(19) United States
(12) Patent Application Publication
(10) Pub. No.: US 2014/0282075 A1
(43) Pub. Date: Sep. 18, 2014

(54) Delivering Experience Opportunities

(71) Applicant: RIBBON LABS, INC., New York, NY (US)

(72) Inventor: Anthony Frank Alfaro, Garden Grove, CA (US)

(73) Assignee: Ribbon Labs, Inc., New York, NY (US)

(21) Appl. No.: 13/803,704

(22) Filed: Mar. 14, 2013

(51) Int. Cl. H04L 29/06

(52) U.S. Cl. CPC H04L 65/403
USPC 715/751

(57) ABSTRACT

Methods, systems, and apparatus are disclosed which include gathering interest data associated with the user, receiving from a user, a future date range, determining that one or more opportunities that match the interest data of the user are associated with the future date range, generating a geographic map including a display of a representation corresponding to each of one or more future locations that are associated with the one or more opportunities that match the interest data of the user, receiving, from the user, a selection one of the representations displayed on the geographic map, and providing for display on the computing device in response to receiving the selection of one of the friend representations, relative to the geographic map, a display of one or more opportunities associated with the respective future location associated with the selected representation.

### BACKGROUND

This disclosure relates generally to geographical information systems.

Web and mobile applications can allow users to make plans for future trips. The data can be gathered and each user can see where his or her friends will be in the future. As new plans are made, friends of the user are updated on these new plans. The user may also want to see not just where his friends, acquaintances, or connections plan to be but where other events, opportunities, or bands he is interested in or might be interested in are going to be in the future, as well as if there are different deals and offers associated with each city he intends to visit, in a specific time range. He is left with accessing other applications or being delivered offers and deals using a number of different websites and/or different applications to get this information. This is often a time consuming task. Opportunities such as deals and offers are not delivered to people as efficiently as they can or should be today.

### SUMMARY

In general, one innovative aspect of the subject matter described in this specification may be embodied in methods that include the actions of gathering interest data associated with the user; receiving from a user, a future date range; determining that one or more opportunities that match the interest data of the user are associated with the future date range; generating a geographic map including a display of the first future date relative to the geographic map, and also including a representation corresponding to each of one or more future locations that are associated with the one or more opportunities that match the interest data of the user; providing the geographic map for display on the computing device; receiving, from the user, a selection one of the representations displayed on the geographic map; and providing for display on the computing device in response to receiving the selection of one of the friend representations, relative to the geographic map a display of one or more opportunities associated with the respective future location associated with the selected representation, wherein the display is displayed relative to the geographic map.

Other embodiments of these aspects include corresponding systems, apparatus, and computer-readable medium storing software comprising instructions executable by one or more computers, which cause the computers to perform the actions of the methods.

Further embodiments, features, and advantages, as well as the structure and operation of the various embodiments are described in detail below with reference to accompanying drawings.

### BRIEF DESCRIPTION OF THE FIGURES

Embodiments are described with reference to the accompanying drawings. In the drawings, like reference numbers may indicate identical or functionally similar elements.

FIG. 1 illustrates a system for communicating future location information.

FIG. 2 illustrates a system for communicating future location information.

FIG. 3 illustrates a display view communicating future location information.

FIG. 4 illustrates a display view communicating future location information.

FIG. 5 illustrates a display view communicating future location information.

FIG. 6 illustrates a flowchart of an example process.

FIG. 7 illustrates an example user device including a browser.

FIG. 8 is a diagram of an example computer device used to implement the system.

### DETAILED DESCRIPTION

Current applications do not allow users to be presented with opportunities based on future location and dates and interests. These opportunities are associated with such things including but not limited to experience opportunities, events, brands, deals, offers, venues, restaurants, airlines and hotels, in the same location on the same dates associated with their intended future plans and based on user interests or friends interests. In one embodiment, the experience opportunities include events, brands, deals, offers, venues, restaurants, airlines, and hotels based on the user interests or friend interests. The experience opportunities can be selected for the user based on the user interests and/or the friend interests. The experience opportunities can also be in the same location as the user on the same dates associated with their intended future plans.

A system will be described that allows users to make future trip plans, and to also be presented with opportunities associated with the future location on the dates of their future trip. A date or date range sometime in the future may be entered or selected using graphic user interface tools of an application. Interest data can be gathered from the user. Geographical locations of friends and/or opportunities associated with the locations are then displayed on a map for the chosen future date or date range. The representations of these geographical locations and date or date ranges may be displayed on a map, including on a geographical information system (GIS) map. As described herein a date range can include a single date.

A geographical location may include a city, a section of a city, a suburb of a city, a region, a metropolitan area, a country, a rural area, a vacation destination, a destination, a park, a place of a scheduled event or any other definable location. In some cases, city sections or nearby cities and towns can be associated with a major or larger city, area, or location. These locations may be annotated with the friend representations to show how many friends are either local or visiting or attending event(s) on the future date(s). These locations can also be annotated with opportunity representations to show what experience opportunities, deals and offers are associated with the future locations the user has conveyed that he or she either intends to visit or is considering visiting. A geographical location name may be altered to convey that the representation (friend an/or opportunity) represents a broader metro area (e.g., Minneapolis-St. Paul), or a popular way of referencing the city (e.g., “SF”). Geographical locations of events, such as sports, concerts, conferences, venues, and festivals, are also displayed on the map and associated with both the actual city or location an event occurs in, and the nearest major city or area.

Once a representation on the map represented is selected, one or more opportunities can be displayed for the user. The user can see what friends are at which locations on the future dates. The user can also be presented with a list of different opportunities associated with the future location on one or more dates in the date or date range selected. The opportunities can include experience opportunities, deals and offers associated with the future location, as will be described in further detail below. The user can then click on any of these opportunities (such as deals and offers) and be directed to an external application to purchase or interact with or engage with the opportunity such as the deal or offer.

The term “friend,” as used herein, may include authentic friends, family members, acquaintances, social connections, professional connections, coworkers, old classmates or colleagues or anyone else that has some relationship with the user or users. A relationship may exist if there has been some type of digital invitation, connection, and/or digital acceptance.

FIG. 1 is a block diagram 100 of a networked system of devices, perhaps mobile devices such as mobile phones, tablets or computers. The devices may be networked over network 102. Network 102 may be any network or combination of networks that can carry data communications. Such a network 102 may include, but is not limited to, a local area network, metropolitan area network, and/or wide area network such as the Internet. Network 102 can support protocols and technology including, but not limited to, World Wide Web (or simply the “Web”), protocols such as a Hypertext Transfer Protocol (“HTTP”) protocols, and/or services. Intermediate web servers, gateways, or other servers may be provided between components of the system shown in FIG. 1, depending upon a particular application or environment.

A user may operate a user interface on user device 110 to determine future location information of friends as well as experience opportunities associated with different locations based on a given date range. In one embodiment, these friends may have provided such information on a limited or restricted basis through their devices 130-134. Future location information may be stored, accessed, distributed or modified using a system stored on and executed by server 120. Permissions may be configured to limit location information for safety reasons. In some aspects, location information may be provided only at the general level, such as only city information.

FIG. 2 illustrates an example system 200 for communicating future locations and delivering opportunities. Future location system 200 includes location determiner 202, location display manager 204, trip/event manager 206 and permission manager 208. System 200 may be implemented on or implemented with one or more computing devices, such as user device 110.

Location determiner 202 is configured to identify future location information of friends. Identification may involve verifying a relationship between a user and a friend. The relationship may be an active digital acceptance or recognition as a “friend.” In some cases, actual friends may be identified from a general pool of digital “friends.” For example, these friends can be from other social networks. Location determiner 202 may check for a most recent status of a friend. Most recent future location information may be obtained or verified with other information about the friend. Permissions and privacy settings will determine what information is identified.

Location determiner 202 is configured to identify future location information of different opportunities, such as deals and offers, or notifications of different events.

Location determiner 202 determines locations for display. This involves receiving a future date or date range and determining geographical locations to display based on the future date and friend future location information. A future date or day or date range may be a day or dates in the future. In some cases, a future date or date range may be considered the present date but a future time on the present date. That future time may be a few hours, a few minutes, or any number of hours, minutes, or any other time period or even in certain cases, one or more seconds in the future. A future date, a future time, or time range may be specific to a day or specific to a week, month or year.

Location determiner 202 determines what friends have submitted or made available information for a future date or date range and what the locations of the friends will be on the date. A future date may also include a future date range, multiple consecutive days, or specific times.

Location determiner 202 also determines what opportunities have been submitted or gathered for a future date or date range.

Location display manager 204 is configured to display one or more determined geographical locations. Geographical locations may be displayed graphically on a map, grid, globe or any three dimensional or multi-dimensional representations. Geographical locations may be displayed in a geographical information system (GIS), which may include city information, location information, roads, terrain or any other information common to GIS maps. For example, display view 300 shows geographical location New York City, N.Y. among nearby cities, roads and other geographical features on GIS map 302. Location display manager 204 can display locations selected by the user. For example, if a user selects NYC, NYC and the surrounding area is displayed.

Location display manager 204 also displays indications or representations of friends as well as opportunities at or near a location on a particular future date. These indications may be friend representations or opportunity representations. In one embodiment, a friend representation can be a FRIENDPIN friend representation. Friend representations are any annotation upon a visual map that provide friend location information specific to the pinned location. Opportunity representations are any annotation upon a visual map that provide opportunity information specific to the pinned location. In one embodiment, an opportunity representation can be an EVENTPIN opportunity representation.

In one embodiment the map can be incorporated into an email to the user, or displayed on a phone to the user, or on the web.

In an embodiment, the friend representation can include a number of friends physically at the location on the future date or future date range. The number can include a total of the number of friends that live at the location and the number of friends visiting that location. The number of friends visiting that location can also include a number of friends attending an event at the location. In a non-limiting embodiment, a friend representation can be a number, more than one number, an image or any combination thereof. In an embodiment, when a friend representation is selected (e.g., mouse click), a list of users visiting or local and/or events can originate from the selected friend representation. Any other user profiles and information may be displayed as well. In an embodiment, if a friend representation includes an indication of a quantity of friends. The indication can include a number, names, images, or a visual indication of quantity such as colors or a gradient. The indication can include friends at an event as well (which are included in the visiting or local indication or it can be a total indication of events and not people. These examples are purely illustrative and are not intended to limit the embodiments. In embodiment, for example, two numbers could be displayed: friends who call the location home and friends visiting the location from another home city.

In another embodiment, the friend representation can include an indication of friends physically at the location on the future date or future date range, as well as the an indication of opportunities associated with the location based on user interests or friend interests. The indication displayed in the friend representation can include, for example, a sum of the number of friends visiting, the number of friends local, the number of events, and the number of opportunities associated with the future location. In another embodiment, the total indication can include the total number of friends visiting, local, and the opportunities associated with the location.

Location display manager 204 also displays indications or representations of opportunities, such as events, deals, offers, and notifications, at or near a location on a particular future date range or date. These representations can be opportunity representations. These representations can include one or more opportunities when clicked on, that will show to the user various deals, and offers associated with brands, stores, places, events, associated with the location on a particular future date range or date. Opportunity representations are any annotation upon a visual map that provide opportunity location information specific to the pinned location. In one embodiment, the opportunity representation provide opportunities associated with any location on the visual map and not just the pinned location.

Location information manager 214 can collect data relating to user's behaviors surrounding different preferences for a variety of offerings. Location information manager 214 can collect data from various social networks such as data associated with users that show a propensity for a brand. For example, a user may “like” a particular brand on a social network or data gathered from use within the application may indicate propensity for a brand. That data can be gathered and stored by the location information manager 214.

Various types of data can be stored. Users may show propensities for various brands including but not limited to sports teams, artists, bands, airlines, hotels, types of food, specific restaurants, general interests such as yoga, clothing brands, clothing stores, drug stores, and so on. This information can be collected and stored by the location information manager 214. These are stored as the user's interests by the location information manager.

Location information manager 214 can use this data to connect a particular user with a particular interest based on a given future date range or future date of a planned future trip or planned future event. A particular user may be going on a future trip or event to a location A, for a week. One of the bands (i.e. music artist) the user has shown a propensity for and for which the information has been stored, may be live in concert at the location or near the location A during those dates. Location information manager 214 can notify the user of the concert when the user is browsing the location using the future date range, by sending or delivering the user these as opportunities.

Location information manager 214 can collect the data associated with these opportunities. For example location information manager 214 can collect these opportunities such restaurant deals or travel deals including dates associated with each deal and locations associated with each deal, airline deals, brand information, and event information such as concert information. Each of these opportunities collected by location information manager 214 is associated with one or more future dates and one or more future locations.

These opportunities can be experience opportunities, deals, offers, and general notifications associated with the user's interests. For example, a deal may be associated with a flight to the particular future city the user is considering visiting. A notification may be an alert of the band for which the user has indicated a propensity.

These opportunities can be displayed for the user in friend representations on the geographic map displayed. The map can display opportunity representations relative to different future locations based on a given date range. Location information manager 214 can determine if any opportunities such as experience opportunities, deals and offers are associated with the future location based on the user interests. The opportunity representation can then be provided to the user.

In one embodiment, these opportunities are delivered by being presented as opportunity representations on a map. A user can click on an opportunity representation and be presented with one or more opportunities of events, brands, restaurants and so on that they have shown a propensity for. When a new future date or future date range is received, the opportunities presented may change based on the dates associated with each opportunity or deal.

In one embodiment, these opportunities are delivered using email to users. Once location information manager 214 determines the user's interests, and receives the dates and a future location, location information manager 214 generates a list of one or more opportunities based on the date, location and interest and emails it to the user. One or more opportunities can be included in each email. A user can set the frequency to receive these emails. Experience opportunities, deals, etc within the emails can be further interactive and engaging with the brands through links and other measures within the email communication.

In one embodiment, the opportunities can be emailed after the user has created a future trip, but before the trip starts. For example an opportunity may be come available after the trip is created and the user is then notified.

In other embodiments, the opportunities can be sent to the user via web, mobile, email, voice including audio and sounds, video, images including 3 dimensional holograms, physical gestures, and motion of the device.

In another embodiment, these opportunities are delivered using notifications to users. The notifications can for example, be push notifications that are sent when an application is installed on a mobile device. Notifications can also be in the form of text/SMS type messages, in-web messaging, and other in-app messaging.

In another embodiment, these opportunities are delivered through a feed that is continuously updating. A feed can be generated for each user to notify the user of each of their friends future trip plans. The feed can also include information regarding the opportunities for the user's own future trips. In one embodiment, the feed can be arranged or organized in a custom fashion or organized by the application in its delivery of the feed by the user either by date of when an event is added or date of the actual event itself.

In one embodiment, the feed for a user can also list various experience opportunities, offers, deals and notifications the user's friends have accepted or purchased or displayed interest in. Therefore, even though the current offer is not displayed to the user because the user's interests may not match, once a friend accepts an offer and the acceptance is displayed in a user's feed, the friend can now purchase that same offer as well.

In one embodiment, the feed is restricted to only friends of the user. A user can also set who can view their feed restricting it to friends, just themselves, friends of friends, or strangers.

The geographical locations chosen for display may be chosen because of size, popularity, frequency of events or trips and other factors. Geographical locations and pins for geographical locations may be selected based on event information that was received. Location display manager 204 is configured to display the locations and pins. Location determiner 202 may provide information to location display manager 204.

User device 110 may be coupled to server 120 over network 102. Server 120, shown in FIG. 2, includes management system 210, which may be used to provide accurate information to user device 110 and friend devices 130-134. Management system 210 includes GIS mapper 212, location information manager 214 and location sharing manager 216. Server 120 may also include location globe repository 220 for globe view information. In a non-limiting embodiment, one or more of location determiner 202, location display manager 204, trip/event manager 206 and permission manager 208 may be included in server 120. In another non-limiting embodiment, one or more of GIS mapper 212, location information manager 214 and location sharing manager 216 may be implemented in future location system 200. In yet another non-limiting embodiment, one or more components of future location system 200 and management system 210 may be distributed across a plurality of computing devices using a cloud computing infrastructure.

In some implementations, GIS mapper 212 may develop maps for display, taking into consideration the location information. The maps may be developed from map information or geographical information system (GIS) data. The displayed maps and corresponding features may vary in detail. In some cases, nearby cities, major roads, natural landmarks, bodies of water, man-made landmarks or other features may be included for context.

Location information manager 214 collects friend future location information submitted by friends on various computing devices. These computing devices may also have an implementation of future location system 200, which works in coordination with management system 210. In some cases, future location information may be submitted or obtained through other applications, interfaces or data feeds.

In one embodiment, location information manager 214 may poll for regular updates or request or receive information asynchronously on an as needed basis. For example, location information manager may poll location globe repository 220 or any other system or database associated with network 102. Information for all friends or for only certain groups of friends may be received. Information may be limited to certain regions. In most cases, all date ranges for friends can be received. In other cases, only select date ranges will be initially received. These date ranges may be only future dates, a year into the future, a month into the future, or other date ranges. A date range determined for display can also include some or all of a location history in order to help a user determine who attended a certain event or location last year.

In some aspects, systems 200 and 210 can be used to display future locations within a city, such as and including, but not limited to, a building, a park, a vacation resort, a venue, a museum, places or smaller levels of detail besides general city information. This may include smaller increments of time, rather than calendar dates. Permission manager 208 may tightly control such specific information through privacy settings and limit the information to specific friends or groups of friends.

Trip and event manager 206 is configured to enable users to create, maintain and share future trip information. Trip manager 206 maintains trip information that has been collected or determined for the user. In some cases, location information manager 214 or location sharing manager 216 may also maintain trip and event information for trip manager 206. Trip information may include a location, a date or date range, friends attending, how long the friends will be there and other information about the trip location or an event at the location. In an embodiment, trip and event manager can communicate with one or more components of future location system 200 and management system 210.

In one implementation, a calendar can be displayed for a user with one or more cities in each day block corresponding to future locations of the user's friends. If more than one friend is in a future location on a given day, the block on the calendar can reflect this. For example, the block can include a city name with a number next to it. The number can represent the number of friends physically present in that location. Clicking on the city can expand to a view where you can see a number of friends visiting that location, a number of friends currently living at that location and a number of events at that location.

GIS mapper 212 may be used to help provide maps and accurate geographical locations and pins. It may obtain updated GIS information. GIS mapper 212 may determine which geographical areas and locations to display based on date information, friend future location information and/or event information.

Location information manager 214 may be used to obtain current friend location information from location entries submitted on user device 110 and friend devices 130-134. Location information manager 214 may be responsible for providing updates for location, trip and event information. Location information manager 214 may store location information. In some cases, future location information related to friends may be stored in secure location globe repository 220. As described above, location globe repository 220 may be used to provide a globe 1902 for display, indicating geographical locations, such as location 1904, having pins or indications of future presence in the geographical location.

In an embodiment, main (or major) geographical locations (or “big cities”) can be established. Such establishment may include selecting which cities are big cities. As a non-limiting example, cities with populations over 250,000 may be considered to be big cities. Such establishment may also involve including surrounding cities or locations that are often associated with a big city, either through public records, online records, public information, social information or user recommendations. Once big cities are established, users or friends of a user may be assigned to these big cities. In an embodiment, such assignment may be automatically done by location, address or other information of a user and associated friends.

Location sharing manager 216 may be used to enable a user to share future location information. A user can share information generally. A user can also share information with specific individuals or groups. Sharing can include posts, email, invites or various methods available through social media. Information specific to a trip or event can be shared.

Implementations of future location system 200 may be provided through a mobile application stored in computer-readable media of user device 110 and executed by one or more processors on the device. The application can display a user interface that is operated by the user. In some implementations, management system 210 may provide the functionality of future location system 200. On other implementations, the functionality of systems 200 and 210 may be provided through a browser.

In an embodiment, system 100 may be used as a platform to integrate other social media platforms, applications and tools. Other applications or platforms may be allowed access, upon an allowing action by a user, to experience opportunities, user-names, future dates and what locations or big cities are associated with future dates for a user. Targeted products and services may be developed based on future location information and locations associated with established big cities It is to be appreciated that the embodiments discussed herein are not limited to big cities and can be utilized with any other types or categories of cities or locations.

In one embodiment the functionality can be used with a search program, for example with Graph Search available through Facebook®. For example, third party search applications might desire to result the experience opportunity data described herein in order to deliver results to their users. For example, a user might search the following on a third party application: “What is going on when I am in Los Angeles in June that I might be interested in doing?” System 104 can deliver these experience opportunity results to the third party application, who in turn may edit or modify these results (or not) and further deliver all or a portion of this data to their users.

In one embodiment, a third party application could have a button (e.g., a “Ribbon” button) that a user selects to simultaneously allow future location system 200 and any other social application, such as Facebook®, that may have associated friend network information for the user so that a user can quickly allow and or share. The user can allow and/or share with a platform, where the user first allows the application to access the various data for his or her future location information and develop friend future location information for his or her friends. The third party application can then use such information to offer products or services corresponding to future experience opportunities, locations, events and trips.

In this way, by maintaining one future location calendar using the presently disclosed embodiments, multiple parties and applications can utilize information from the future location calendar to provide opportunities for a user to maximize the user's enjoyment of a future trip or event.

The representation can show a number of friends that live or consider home base at that location on the future date, a number of friends that are visiting the future location on the future date, a number of events that are occurring at the future location on the map on the future date including the number of friends and related friend information for those attending such events, a number of deals associated with the location on the future date or date range, as well as a number of offers associated with the location on the future date or date range. In one embodiment, the representation or friend representation can include a sum or visual indication of quantity or total of all of these.

In an embodiment, the opportunity representation or friend representation may include an image of a person (or friend) that is associated with a location corresponding to the friend representation and presented by the friend representation, or an image of an experience opportunity, offer or deal associated with the opportunity representation. In an embodiment, each representation may be any other representation or marker that includes a dynamic content area surrounded by a static border. The dynamic content area may include, for example, an image of a person (or friend) that is associated with a location represented by the marker, an image of a restaurant, a band, a brand and so on. The user and the one or more friends can be associated with a social or other network.

In one embodiment, on the web, a user can engage with time by moving a slider (or horizontal or vertical or other ruler or linear design). The slider can be moved forward or backward, or up or down, to move time forward and/or backwards.

In other embodiments, the user can engage with time using physical gestures and the motion of the device. Not sure where you note in this application.

In one embodiment, an indication of a selection of a representation of a respective future location can be received. Fore example, a user can select one of the representations, for example one of the friend representations, opportunity representations, or pushpins on the map. In response to receiving the indication of the selection, a list can be displayed. The list can correspond to the representation. The list can show the one or more friends that live at location on the future date, one or more friends that are visiting the location on the future date, one or more events occurring at the location on the future date, one or more experience opportunities, deals associated with the location, or one or more offers associated with the location. In one embodiment, deals and offers are selected based on the user interests.

In one embodiment, the list can display a list of names of friends of the user that are local to the future location in the dynamic content area associated with the one friend representation, a list of names of friends of the user that are visiting the future location in the dynamic content area associated with the one friend representation, a list of names of events at the future location that one or more friends are attending corresponding to the future location in the dynamic content area associated with the one representation, a list of one or more offers associated with the future location, and a list of one or more deals. Each list can be displayed in its own column or its own tap in the dynamic display area.

In one embodiment, clicking on a name in one of the lists displays a profile associated with the user. The profile can indicate specifics regarding the user for example, where they live, their future trips or events and dates associated with each future trip or event.

In one embodiment, clicking on the name of an event will display an event profile. The event profile can include a date or dates associated with the event as well as one or more people attending the event. If one of the people attending is a friend of the user, an indication can be displayed relative to each friend that indicates that the particular friend is a friend of the user.

FIG. 3 is an example geographic map with representations. The map can be, for example, a TIMEMAP map. Once a future date 302 is received, in this example, Mar. 25, 2014, representations such as 304 and 306 can be displayed on the map 308. The user can select a future date 302 that is a single date or a date range. Representation 304 can be a friend representation or an opportunity representation. Representation 304 indicate the number 15 in Philadelphia.

Any method can be used to receive the future date 302 from the user. In this example a timeline reel is used. A user can instead enter a date range for the future date 302.

In one embodiment, a friend representation can include a profile image within the friend representation or a group of friend representations, each with a friend profile image within each friend representation.

In another embodiment, the representation 304 can include a single number. The single number can include a total of the number of friends visiting the future location and a number of friends that are local to that location. If for example, the total number (or visual indication of quantity) was 10 (or “many”), it may be the case that 3 (or a “few”) friends live at that location, and 7 are visiting the location. Any number of the 7 friends visiting the location or 3 friends that live at the location may be attending an event (or events) at the location and this number of friends is included in the 7 friends visiting and 3 friends that live at the future location. For example, if 7 are visiting and of those 7, 3 are attending an event, then the 3 is included in the 7 visiting. In another embodiment, these two numbers (number of friends attending events versus number of visiting and local friends) can be distinct so if a friend is at an event at the future location, they are excluded from the visiting list. The visiting list can be for friends visiting the city but not necessarily associated with an event at the city.

In one embodiment, the number displayed, or some visual indication of quantity, can also include the number of opportunities associated with that city or location as well. In another embodiment, the number (or some visual indication of quantity) may only represent the number of opportunities associated with Philadelphia that match the user's interests.

In one embodiment, clicking on a representation with a single number (or some visual indication of quantity) can expand the representation into the same number of representations as the number (or visual indication) on the original friend representation.

In one embodiment, when a representation is selected, along with the friend information of who is visiting the location associated with the friend representation and who is local, one or more opportunities can be presented to the user that are associated with the location and the future date range or future date selected. The opportunities can include deals and offers associated with one or more entities related to the location. These opportunities can be based on the user's interests or data collected.

In one embodiment, if the opportunity, deal or event is associated with a date or date range that is a predetermined number of days away from the future date or future date range selected, the opportunity can still be presented to the user. Therefore, even though the date associated with the opportunity is not the same date or does not fall within the same date range as the future date or date range selected the opportunity is still presented to the user. An administrator or a user can select the predetermined number of days. For example, the predetermined number of days can be 3 or 4. Therefore the user may change their date range to include the date associated with the opportunity, deal, or event to be able to take advantage of this offer.

In one embodiment, the opportunities, deals or events can be delivered to user via email. If a user creates a future trip for a future location on a future time range, this trip information is stored. If there is an opportunity, deal or event that is associated with a future date that is a predetermined number of days away from the future date of the offer, user can get notifications of these offers even though the offers are not associated with the exact date of their trip. The opportunities, deals, and events can be tied to user interests and data collected, and the frequency of the emails can be determined by the user or administrator of the application.

In another embodiment, if a user creates a future trip for a future location on a future time range, this trip information is stored. If there is an opportunity, deal or event is associated with a location that is a predetermined distance from the location of the user's future trip the user can get notifications of these offers event though they are not associated with the exact location of the user's future trip. The opportunities, deals, and events can be tied to user interests, and the frequency of the emails can be determined by the user or administrator of the application.

In one embodiment, the user is notified of these opportunities via voice notification. Opportunities can be delivered to users by voice within the phone and mobile applications by the user making a selection within the application and/or speaking to the application requesting delivery of experience opportunities or any other user related data. Experience opportunities may be packaged with other data such as user friend connections and delivered to the user via voice as one stream of content. Voice delivery or request methods can deliver the user opportunities, deals, offers, that match the user's criteria for a future date range and location. In another embodiment the voice delivery, notifications, interaction, and engagement can communicate, notify, or interact with the user of deals, opportunities and events that are associated with nearby locations, of cities that are a predetermined distance from a location selected by a user for a future trip. In another embodiment the voice notifications can deliver, notify, interact, and engage with the user of deals, opportunities, and events that are associated with dates that are a predetermined number of dates away from dates associated with a user's future trip.

In one embodiment, when a user can select a month view, a week view, or a year view when selecting future date ranges. The user can either pick a month, for example, February to view the experience opportunities associated with the month of February for various or specific locations. The user can also view friend representations associated with these alternative views of date ranges. In one embodiment, the user can select to see all experience opportunities without any time constraints. Therefore they can select to see all the experience opportunities without a limit on time.

In one embodiment, instead of displaying a map with representations, a list can just be displayed with the experience opportunities. A user can select a date range and/or location, and if there are experience opportunities associated with the date range or with dates within a predetermined number of dates (for example 7-10 days) from the experience opportunity date ranges, the user can be presented a list with these opportunities. In another embodiment the list can be emailed to the user or presented to the user in another form of a notification such as a push notification from a mobile device, a web notification or voice notification as discussed above, video delivery, image delivery or delivery in a user feed.

In another embodiment, a user can create a future trip, such as going to a future location or a future event. System 104 can store this data and notify the user via email, push notifications, voice, web notifications, in-app notifications, mobile notifications, the feed, video, and images including 3 dimensional holograms.

In one embodiment, the experience opportunities that either fall within the date or date range of the user's trip, or within a reasonable amount of days before or after the trip whereby the user may want to change his trip dates to experience the opportunity; for example 7-10 days before or after the dates from the user's date or date range. In another embodiment, experience opportunities can be sent to the user via email, mobile notifications, web notifications, voice or video, or image notifications of experience opportunities associated with future locations within a predetermined distance such as number of miles, or other measure or determination of distance away from the user's future trip.

In one embodiment any email sent to the user can also include a map representation showing the experience opportunities and/or a list of the experience opportunities. In another embodiment, the email can include a voice recoding of the experience opportunities or a link to a voice recording of the experience opportunities. In another embodiment, the email can contain images including 3 dimensional holograms of the experience opportunities.

In one embodiment, the user can engage with the experience opportunity such as clicking on a link to purchase, engage, or interact with an offer associated with the experience opportunity, or click on a link to be taken to a company's application associated with the experience opportunity. The user can be presented with these options in emails that are sent to them, on the visual map display, in a list form in an email or on a map, or through mobile or web push notifications; or audio, video, or images.

In other embodiments, the opportunities can be delivered via mobile and web notifications, email, audio, video, images including three dimension holograms.

In one embodiment, the opportunities can include airline or hotel deals associated with the future location on the future date range. The airline or hotel deal can list the airline or hotel as well as the price associated with the flight or hotel offer.

In one embodiment, the opportunities can include a discounted offer for a restaurant associated with the future location. The restaurants can be ones that the user has indicated a propensity for and is included and/or inferred in the user's interests.

In one embodiment, the opportunities can include a sport event opportunity associated with the respective future location. The sports events can be based on the user's interests.

In one embodiment, the opportunities can include a concert event associated with the respective future location. The concert events can be based on the user's interests.

In one embodiment, the opportunities can include news associated with the respective future location. The news can be based on the user's interests. For example, if a user indicates he/she likes a particular news website or news brand or news category such as technology.

While a new future date or date range is received, representations and associated location numbers may dynamically change to match the dates during the sliding motion.

For example, an opportunity representation may be a number 6 (or visual indication of quantity) on New York City on one future date or date range, and different numbers or indications for New York City on a second future date or date range. Therefore different number or indications of opportunities are available for that city (or location) based on the new future date, for the user currently using the system. The opportunities can be selected and included in a representation based on the user's interests.

In a non-limiting embodiment, when a date or date range is selected, location determiner 202 utilizes the date selected in date display 302 as a future date. Location determiner 202 determines locations for display based on the future date and determines geographical locations to display based on the future date and friend future location information. As noted above, location determiner 202 determines what friends have submitted or made available information for a future date and what the locations of the friends will be on the date. A future date may also include a future date range, multiple consecutive days, or specific times. In an embodiment, as a date range is being selected one or more requests for future friend locations for the selected dates may be sent to location determiner 210 and/or management system 210. Location display manager 204 causes friend representations and associated friend location numbers to dynamically change to match the dates during the sliding motion along ribbon 304 and displays indications of friends at or near a location at the selected future date.

Map 308, or geographical location representations visible on map 308, may reflect other destinations that can be zoomed in and out based on user preferences and selections. Different filters or time increments may be chosen. Other visual aids can be used for pins 308 and 310.

FIG. 4 illustrates example display view after a representation has been selected. In an embodiment, when representation 402 is selected other representations that may be previously displayed fade out or are hidden from display and a list 404 may originate from representation 402. List 404 illustrates, for example, identities of users visiting a location (e.g., Philadelphia), as well as visiting Philadelphia, as well as a number of opportunities 406 associated with Philadelphia specific to the current user. Referring, to list 404, it can be seen that nine individuals are visiting Philadelphia and nine friends (hidden from display) are local to Philadelphia, there are six events in Philadelphia, and there are three opportunities associated with Philadelphia. In this way, list 404 may include tabs (e.g., Visiting, Local, opportunities, etc.) to display, for example, visiting friends, local friends, and opportunities in their respective tabs. In an embodiment, user interface display operations, such as fading or hiding pins from display, may be performed by location display manager 204.

In one embodiment, when a user enters a date range and the geographic map displays representations of various friends visiting the particular future location during the date range, the representations can only include a list of opportunities such as deals, offers, and notifications, specific to the current user. In one embodiment, the opportunities are presented in friend representations even without the list of friends.

As described, two different types of representations can be used. One friend representation represents the friends that are local and visiting the future location on the future date range selected by the user. The other representation on the map is an opportunity representation that is not related to any friends visiting or local to the city.

FIG. 5 illustrates a geographic map with representations. A future date 502 is received from the user. Based on the future date and the current user's interest, the system can generate representations on a map for various opportunities for the user. In this example, representation 504 is generated for New York. When representation 504 is clicked on, a list 506 is displayed for the user that lists various opportunities the user may be interested in based on their interests. For example, experience opportunities, or deals can be displayed for airlines, hotels, restaurant deals, as well as concert notifications.

FIG. 6 illustrates a flowchart of an example process 600. The process may be implemented by future location system 200 or management system 210.

At stage 610, interest data associated with the user is gathered.

At stage 620, a future date range is received from a user. A date range can include a single date.

At stage 630, a determination is made that one or more opportunities that match the interest data of the user are associated with the future date range received from the user.

At stage 640, a geographic map is generated, including a display of the first future date relative to the geographic map, and also including a representation corresponding to each of one or more future locations that are associated with the one or more opportunities that match the interest data of the user.

At stage 650, the geographic map is provided for display on the computing device.

At stage 660, a selection one of the representations displayed on the geographic map is received from the user.

At stage 670, a display of one or more opportunities associated with the respective future location associated with the selected representation are providing for display on the computing device in response to receiving the selection of one of the friend representations, relative to the geographic map, wherein the display is displayed relative to the geographic map. The opportunities can include an airline offer to fly to the future location, a hotel offer to stay related to a future location, a discounted offer for a restaurant associated with the future location, a sport event opportunity associated with the respective future location, a concert event associated with the respective future location, news associated with the respective future location, and weather associated with the respective future location. In one embodiment, the display can be a list.

In one embodiment, the representations on the future locations on the geographic map can be dynamically updated based on a new future date range received.

In one embodiment, one or more friends of a user can be identified, wherein the user and the one or more friends are connected in a social network. For each of the one or more friends, future trip information of the one or more friends can be gathered, the trip information including respective second future date ranges and corresponding future locations indicating respective physical locations of each of the one or more friends on the respective second future date ranges. A determined can be made based on the gathered trip information, that one or more friends of the user are going to be physically present at one or more respective future locations on a respective second future date range that overlaps with the first future date range, and the one or more friends that are associated with the future location can be includes in the list along with the list of opportunities.

In an embodiment, the functionality of future location system 200 and/or management system 210 may be provided through a browser on computing devices, such as user device 110. Management system 210 on server 120 may host the service and serve it to device 110 and any other computing devices. Any combination of implementations may provide, through a browser, the functionality represented by the example implementations of systems 200 and 210 shown in FIG. 2 and in the display views and flowchart of FIG. 6. Any stages shown in flowchart 600 that involve displaying content may be considered to provide the content for display in a browser.

For example, FIG. 7 shows user device 110 executing browser 702. Browser 702 may be any commonly used browser, including any multi-threaded or multi-process browser. In an embodiment, the functionality of future location system 200 can be provided through browser 702. Future dates are received or displayed in browser 702. Friend future location information is shown using geographical representations through browser 702.

In another implementation, the current location of the user is shown in box 3208 on the map. This may include a map of a geographical location of the user on the selected date. A pin may be shown, with or without future friend location information. Box 3208 may enable a user to find himself or herself on a particular date. This allows a user to explore future locations of friends while simultaneously showing the future location calendar of the user.

The functionality of any of the components or flowcharts shown in FIGS. 1-7 may be provided through a browser executed on device 110, server 120 or any other computing device. The web pages or application provided through the browser may be served from server 120, device 110, or any other computing device. Different windows or views may be shown through browser 702. Different permissions or filters may be established based on the identity or roles of the individual logging into a website view.

The functionality can be implemented on an application on a mobile device or through the web on a computing device.

Implementations of the system provide a way for friends to communicate a future location status. Friends can plan trips and know where friends will be. Instead of having to call, email or text multiple friends about their future plans on a regular basis, friends can check the future location information of their friends and plan accordingly. Discussions, interactions, and engagement can ensue based on proposed or planned attendance of a future trip or event.

In an embodiment, future location system 200 or server 120 utilizes a location based methodology (or algorithm) that organizes people and locations into areas whereby people can “reasonably” visit each other while in that same location. Extensive factors are included within an algorithm determining location groups, including, but not limited to, various weightings of population, geographical data such as metropolitan, rural, and city data; transportation infrastructure, community data, education data, social data, commerce data, airport presence, and political data. Such geographical location groupings may be known as “Big Cities.” In an embodiment, future location system 200 creates such groupings of location commensurate with how future location system 200 groups people and friends.

As discussed above, future location system 200 enables people to share where they are going or plan to be in the future. Users can see where their friends are going, and users need not be present where their friends are located. For example, a user can see from a display of future location system 200 that the user's friend is New York. Based upon this knowledge, the user can suggest another friend of the user to the friend located in New York. The users friend in New York can then be “Ribbon” friends. As discussed herein, Ribbon users may refer to users who have signed up to use future location system 200 or have a user account with future location system 100. Similarly, Ribbon friends refer to Ribbon users who may be digitally connected to each other using future location system 200.

In an embodiment, future location system 200 enables users to block the ability to view a their future location on a case by case basis (e.g., friend by friend basis; or person to person basis). Furthermore, future location system 200 enables a user to block friends ability to see the user's future locations before those friends become socially connected to the user though future location system 200 (or become Ribbon users or “Ribbon Friends”. In other words, for example, a user can preempt privacy by “blocking” other individuals immediately once the other individuals become Ribbon users. Furthermore, because a user signing into future location system 200 may usually sign up through third party sites such as Facebook®, future location system 200 can review the user's entire friend network on Facebook® and will organize all of these friends into respective locations on a user interface associated with future location system 200 based at least on locations of those friends. The user can preempt privacy by using the user interface to block, which friends the user wants to block. When those blocked friends eventually become Ribbon users, they are automatically blocked from seeing the users future locations because they have previously been blocked.

In an embodiment, future location system 200 may enable a user to denote or mark their location as a “big city.” As discussed above, and in a non-limiting embodiment, various weightings of population, geographical data such as metropolitan, rural, and city data; transportation infrastructure, community data, education data, social data, commerce data, airport presence, and political data may be used to create geographical location groupings known as “big cities.” In this way, by sharing their location as a big city, users need not share a more specific location such as a county, event or even address with other users. This improves user privacy.

System 100 including future location system 200 can act as a platform connecting people, brands, services, events, etc in both. time and place. Furthermore, third party applications, including, but not limited to, Groupon, Living Social, Facebook, Kayak, Expedia, and others would be able to deliver their users deals, services, and information with knowledge of where their users, fans, and followers would be in the future based on information provided by future location system 200.

System 200 may be software, firmware, or hardware or any combination thereof in a computing device. A computing device can be any type of computing device having one or more processors. For example, a computing device can be a computer, server, workstation, mobile device (e.g., a mobile phone, personal digital assistant, navigation device, tablet, laptop, or any other user carried device), game console, set-top box, kiosk, embedded system or other device having at least one processor and memory. A computing device may include a communication port or I/O device for communicating over wired or wireless communication link(s).

Computing devices such as a monitor, all-in-one computer, smart phone, tablet computer, remote control, etc., may include a touch screen display that accepts user input via touching operations performed by a user's fingers or other instrument. For example purposes, a touch sensor grid may overlay the display area. The touch sensor grid contains many touch sensitive areas or cells that may be used to locate the area closest to the input of a user's touch.

Example touch operations using a touch screen display may include (but are not limited to) pinching, finger (or other stylus or object) touches, finger releases, and finger slides. Finger slides may be circular or any other shape, direction or pattern. The touch screen display may include a screen or monitor that may render text and/or images.

FIG. 8 is an example computer system 800 in which embodiments of the present invention, or portions thereof, may be implemented as computer-readable code. For example, the components of systems 200 and 210 may be implemented in one or more computer systems 800 using hardware, software implemented with hardware, firmware, tangible computer-readable media having instructions stored thereon, or a combination thereof and may be implemented in one or more computer systems or other processing systems. Components in FIGS. 1-7 may be embodied in any combination of hardware and software.

Computing devices, such as devices 110 and 130-134 or server 120, may include one or more processors 802, one or more non-volatile storage mediums 804, one or more memory devices 806, a communication infrastructure 808, a display screen 810 and a communication interface 812.

Processors 802 may include any conventional or special purpose processor, including, but not limited to, digital signal processor (DSP), field programmable gate array (FPGA), application specific integrated circuit (ASIC), and multi-core processors.

GPU 814 is a specialized processor that executes instructions and programs, selected for complex graphics and mathematical operations, in parallel.

Non-volatile storage 804 may include one or more of a hard disk drive, flash memory, and like devices that may store computer program instructions and data on computer-readable media. One or more of non-volatile storage device 3404 may be a removable storage device.

Memory devices 806 may include one or more volatile memory devices such as but not limited to, random access memory. Communication infrastructure 3408 may include one or more device interconnection buses such as Ethernet, Peripheral Component Interconnect (PCI), and the like.

Typically, computer instructions are executed using one or more processors 802 and can be stored in non-volatile storage medium 804 or memory devices 806.

Display screen 810 allows results of the computer operations to be displayed to a user or an application developer.

Communication interface 812 allows software and data to be transferred between computer system 800 and external devices. Communication interface 812 may include a modem, a network interface (such as an Ethernet card), a communications port, a PCMCIA slot and card, or the like. Software and data transferred via communication interface 812 may be in the form of signals, which may be electronic, electromagnetic, optical, or other signals capable of being received by communication interface 812. These signals may be provided to communication interface 812 via a communications path. The communications path carries signals and may be implemented using wire or cable, fiber optics, a phone line, a cellular phone link, an RF link or other communications channels.

Embodiments also may be directed to computer program products comprising software stored on any computer-useable medium. Such software, when executed in one or more data processing device, causes a data processing device(s) to operate as described herein.

Embodiments of the invention employ any computer-useable or readable medium. Examples of computer-useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein.

The breadth and scope of the present invention should not be limited by any of the above-described exemplary embodiments or any actual software code with the specialized control of hardware to implement such embodiments, but should be defined only in accordance with the following claims and their equivalents.

What is claimed is:

1. A computer-implemented method comprising:
gathering interest data associated with a user;
receiving from the user, a future date range;
determining that one or more opportunities match the interest data of the user are associated with the future date range;
generating a geographic map including a display of the first future date relative to the geographic map, and also including a representation corresponding to each of one or more future locations that are associated with the one or more opportunities that match the interest data of the user;
providing the geographic map for display on the computing device;
receiving, from the user, a selection one of the representations displayed on the geographic map; and
providing for display on the computing device in response to receiving the selection of one of the friend representations, relative to the geographic map, a display of one or more opportunities associated with the respective future location associated with the selected representation, wherein the display is displayed relative to the geographic map.

2. The method of claim 1, wherein each opportunity includes at least one of:
an airline offer to fly to the future location;
a hotel offer to stay related to a future location;
a discounted offer for a restaurant associated with the future location;
a sport event opportunity associated with the respective future location;
a concert event associated with the respective future location;
news associated with the respective future location weather associated with the respective future location.

3. The method of claim 1, further comprising:
dynamically updating the representations on the future locations on the geographic map based on a new future date range received.

4. The method of claim 1, wherein the representations display at least one of a number of opportunities with the respective future location associated with the representation.

5. The method of claim 1, further comprising:
identifying one or more friends of a user, wherein the user and the one or more friends are connected in a social network;
for each of the one or more friends, gathering future trip information of the one or more friends, the trip information including respective second future date ranges and corresponding future locations indicating respective physical locations of each of the one or more friends on the respective second future date ranges;
determining, based on the gathered trip information, that one or more friends of the user are going to be physically present at one or more respective future locations on a respective second future date range that overlaps with the first future date range; and
including in the display, the one or more friends that are associated with the future location along with the display of opportunities.

6. The method of claim 1, further comprising:
receiving an indication to purchase, interact, or engage one or more of the opportunities.

7. The method of claim 1, wherein the opportunities are further delivered to the user in a feed.

8. A system comprising: one or more computers and one or more storage devices storing instructions that are operable, when executed by the one or more computers, to cause the one or more computers to perform operations comprising:
gathering interest data associated with the user;
receiving from a user a future date range;
determining that one or more opportunities that match the interest data of the user are associated with the future date range;
generating a geographic map including a display of the first future date relative to the geographic map, and also including a representation corresponding to each of one or more future locations that are associated with the one or more opportunities that match the interest data of the user;
providing the geographic map for display on the computing device;
receiving, from the user, a selection one of the representations displayed on the geographic map; and
providing for display on the computing device in response to receiving the selection of one of the friend representations, relative to the geographic map, a display of one or more opportunities associated with the respective future location associated with the selected representation, wherein the display is displayed relative to the geographic map.

9. The system of claim 8, wherein each opportunity includes at least one of:
an airline offer to fly to the future location;
a hotel offer to stay related to a future location;
a discounted offer for a restaurant associated with the future location;
a sport event opportunity associated with the respective future location;
a concert event associated with the respective future location;
news associated with the respective future location
weather associated with the respective future location

10. The system of claim 8, wherein the operations further comprise:
dynamically updating the friend representations on the future locations on the geographic map based on a third future date received.

11. The system of claim 8, wherein the representations displays at least one of a number of opportunities with the respective future location associated with the representation.

12. The system of claim 8, wherein the operations further comprise:
gathering interest data associated with the user;
receiving from a user, a future date range;
determining that one or more opportunities that match the interest data of the user are associated with the future date range;
generating a geographic map including a display of the first future date relative to the geographic map, and also including a representation corresponding to each of one or more future locations that are associated with the one or more opportunities that match the interest data of the user;
providing the geographic map for display on the computing device;
receiving, from the user, a selection one of the representations displayed on the geographic map; and
providing for display on the computing device in response to receiving the selection of one of the friend representations, relative to the geographic map a display of one or more opportunities associated with the respective future location associated with the selected representation, wherein the display is displayed relative to the geographic map.

13. The system of claim 8, wherein the operations further comprise:
receiving an indication to purchase, interact, or engage one or more of the opportunities.

14. The system of claim 8, wherein the opportunities are further delivered to the user in a feed.

15. A non-transitory computer-readable medium storing software comprising instructions executable by one or more computers which, upon said execution, cause the one or more computers to perform operations comprising:
gathering interest data associated with the user;
receiving from a user, a future date range;
determining that one or more opportunities that match the interest data of the user are associated with the future date range;
generating a geographic map including a display of the first future date relative to the geographic map, and also including a representation corresponding to each of one or more future locations that are associated with the one or more opportunities that match the interest data of the user;
providing the geographic map for display on the computing device;
receiving, from the user, a selection one of the representations displayed on the geographic map; and
providing for display on the computing device in response to receiving the selection of one of the friend representations, relative to the geographic map, a display of one or more opportunities associated with the respective future location associated with the selected representation, wherein the display is displayed relative to the geographic map.

16. The non-transitory computer-readable medium of claim 15, wherein each opportunity includes at least one of:
an airline offer to fly to the future location;
a hotel offer to stay related to a future location;
a discounted offer for a restaurant associated with the future location;
a sport event opportunity associated with the respective future location;
a concert event associated with the respective future location;
news associated with the respective future location
weather associated with the respective future location

17. The non-transitory computer-readable medium of claim 15, further comprising:
dynamically updating the friend representations on the future locations on the geographic map based on a third future date received.

18. The non-transitory computer-readable medium of claim 15, wherein the representations displays at least one of a number of opportunities with the respective future location associated with the representation.

19. The non-transitory computer-readable medium of claim 15, wherein the operations further comprise;
identifying one or more friends of a user, wherein the user and the one or more friends are connected in a social network;
for each of the one or more friends, gathering future trip information of the one or more friends, the trip information including respective second future date ranges and corresponding future locations indicating respective physical locations of each of the one or more friends on the respective second future date ranges;
determining, based on the gathered trip information, that one or more friends of the user are going to be physically present at one or more respective future locations on a respective second future date range that overlaps with the first future date range; and
including in the display, the one or more friends that are associated with the future location along with the display of opportunities.

20. The non-transitory computer-readable medium of claim 15, wherein the operations further comprise:
receiving an indication to purchase, interact, or engage one or more of the opportunities.
